(19) United States
(12) Patent Application Publication
(10) Pub. No.: US 2023/0203972 A1
(43) Pub. Date: Jun. 29, 2023

(54) ALL-DIRECTION FLOW-THROUGH FLOW DIRECTING MEMBER WITH ANGLED BAFFLES

(71) Applicant: Cummins Filtration Inc., Nashville, TN (US)

(72) Inventors: Benjamin L. Scheckel, Stoughton, WI (US); Joseph Appelhans, Belvidere, IL (US); Janhavi C. Fadnavis, Pune (IN); Xuerui Gu, Fitchburg, WI (US)

(73) Assignee: Cummins Filtration Inc., Nashville, TN (US)

(21) Appl. No.: 18/111,132

(22) Filed: Feb. 17, 2023

Related U.S. Application Data
(63) Continuation of application No. PCT/US2021/046672, filed on Aug. 19, 2021.

(30) Foreign Application Priority Data
Aug. 20, 2020 (IN) 202041035938

(51) Int. Cl. F01M 13/04; B01D 46/00; B01D 46/10

(52) U.S. Cl. CPC F01M 13/0405; B01D 46/0047; B01D 46/10; F01M 2013/0433; F01M 2013/0438

(57) ABSTRACT

A crankcase ventilation device includes a housing and a flow directing member. The housing defines an inlet, an outlet and an internal volume. The inlet is configured to receive blow-by from an engine. The flow directing member is coupled to the housing and extends into the internal volume. The flow directing member includes a plurality of sidewalls, at least two of the plurality of sidewalls defining a window that fluidly couples the inlet to the internal volume. A filter media may be coupled to the flow directing member.

### CROSS-REFERENCE TO RELATED PATENT APPLICATIONS

This application is a continuation of PCT Application No. PCT/2021/046672, filed Aug. 19, 2021 which claims the benefit of and priority to Indian Provisional Patent Application No. 202041035938, filed Aug. 20, 2020. The contents of these applications are incorporated herein by reference in its entirety.

### TECHNICAL FIELD

The present disclosure generally relates to filtration systems for internal combustion engine systems. More specifically, this disclosure relates to crankcase ventilation systems for separating oil from engine crankcase blow-by.

### BACKGROUND

Internal combustion engine systems require oil for lubrication of moving parts. During engine operation, blow-by is generated from combustion gases that leak past the piston rings. The blow-by includes pressurized gas that is laden with oil droplets (e.g., aerosol, etc.). Many existing engine systems include crankcase ventilation systems and devices to filter the oil droplets from the blow-by gas. However, because of the high flow rates of blow-by experienced in some applications, and the limited envelope of available space for auxiliary components in the engine compartment, the performance of the crankcase ventilation system may be limited.

### SUMMARY OF THE INVENTION

One embodiment of the present disclosure relates to a crankcase ventilation device. The crankcase ventilation device includes a housing and a flow directing member. The housing defines an inlet, an outlet, and an internal volume. The inlet is configured to receive blow-by from an engine. The flow directing member is coupled to the housing and extends into the internal volume. The flow directing member includes a plurality of sidewalls, at least two of the plurality of sidewalls defining a window that fluidly couples the inlet to the internal volume. A filter media may be coupled to the flow directing member.

Another embodiment of the present disclosure relates to a flow directing member. The flow directing member includes a body comprising a plurality of sidewalls. The plurality of sidewalls together define an interior cavity sized to receive a filter media therein. The plurality of sidewalls comprises a first sidewall defining an opening, and a second sidewall and a third sidewall coupled to the first sidewall. Each of the first sidewall and the second sidewall defines a window that is fluidly coupled to the opening by the interior cavity.

Another embodiment of the present disclosure relates to a flow directing member. The flow directing member includes a body and a flow directing baffle. The body includes a plurality of sidewalls. The plurality of sidewalls together define an interior cavity sized to receive a filter media therein. The plurality of sidewalls includes a first sidewall defining a window. The flow directing baffle is disposed along an edge of the window and extends away from the first sidewall at an oblique angle relative to the first sidewall.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a perspective view of a housing portion and flow directing member of a crankcase ventilation device, according to an embodiment.

FIG. 2 is a perspective view of a simulated velocity profile through the crankcase ventilation device of FIG. 1.

FIG. 3 is perspective view of a housing portion and flow directing member of a crankcase ventilation device, according to another embodiment.

FIG. 4 is a top view of the housing portion and flow directing member of FIG. 3.

FIG. 5 is a front perspective view of a flow directing member portion of the crankcase ventilation device of FIG. 3.

FIG. 6 is another perspective view of the flow directing member portion of FIG. 5.

FIG. 7 is a perspective view of a simulated velocity profile through the crankcase ventilation device of FIG. 3.

FIG. 8 is a perspective view of a flow directing member of a crankcase ventilation device, according to an embodiment.

FIG. 9 is a perspective view of a flow directing member of a crankcase ventilation device, according to another embodiment.

FIG. 10 is a perspective view of a flow directing member of a crankcase ventilation device, according to another embodiment.

FIG. 11 is a perspective view of a flow directing member portion of a crankcase ventilation device, according to an embodiment.

FIG. 12 is a side cross-sectional view of a flow directing member of a crankcase ventilation device, according to another embodiment.

FIG. 13 is a top cross-sectional view of the flow directing member of FIG. 12.

FIG. 14 is a perspective view of a flow directing member of a crankcase ventilation device, according to another embodiment.

FIG. 15 is another perspective view of the flow directing member of FIG. 14.

FIG. 16 is a top view of the flow directing member of FIG. 14.

FIG. 17 is a perspective view of a flow directing member of a crankcase ventilation device, according to still another embodiment.

FIG. 18 is another perspective view of the flow directing member of FIG. 17.

FIG. 19 is a top view of the flow directing member of FIG. 17.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to crankcase ventilation systems and devices for internal combustion engine systems. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

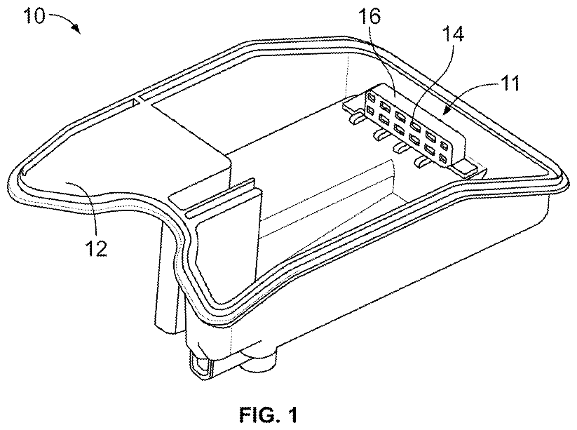

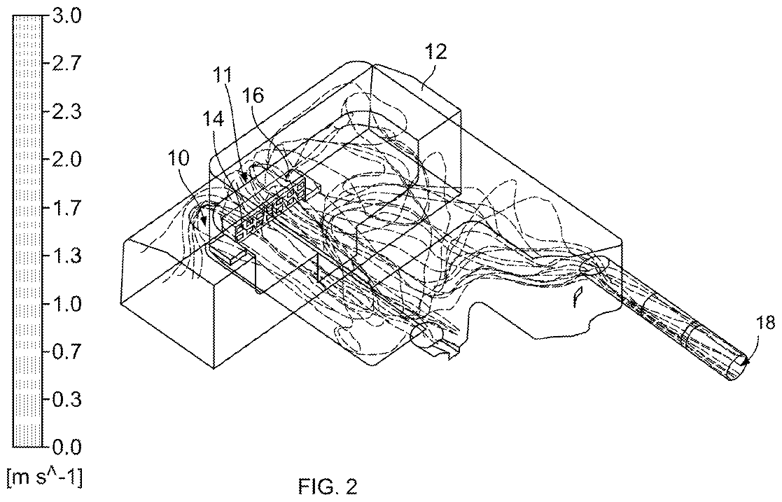

Crankcase ventilation devices (e.g., breathers, impactors, etc.) filter oil from blow-by generated during the combustion process to remove oil aerosol from the blow-by and return the separated oil to the engine crankcase. As shown in FIGS. 1-2, a first example crankcase ventilation device 10 includes a housing 12 and a filter media 14. As shown in FIG. 2, blow-by is routed through the housing 12 (e.g., an inlet 11 to the housing 12), through openings on a back side of a flow directing member 16 (toward the filter media), and impacted on the filter media 14 at high velocity so as to capture and separate oil from the blow-by. The blow-by is routed into the housing 12 from an inlet 11 and through the flow directing member 16. From the flow directing member 16, the filtered blow-by is exhausted through an outlet 18 in the housing 12. In some instances, the high flow rate of blow-by through the flow directing member 16, combined with the space constraints on the overall size of the housing 12, causes the continuous fluid velocity that can be achieved from the inlet 11 to the outlet 18 to exceed a maximum threshold.

Embodiments of the present disclosure reduce the above-noted performance issues by incorporating windows into the flow directing member that allow flow to pass through multiple surfaces of the flow directing member. The windows are sized to control the flow volume through each surface of the flow directing member. The crankcase ventilation device (e.g., the flow directing member and the housing) also include baffles, which are angled in different directions (e.g., two different directions) to distribute the flow throughout the housing, reduce dead volume (e.g., areas of flow recirculation, etc.), and improve overall liquid separation performance.

### II. Example Crankcase Ventilation Device

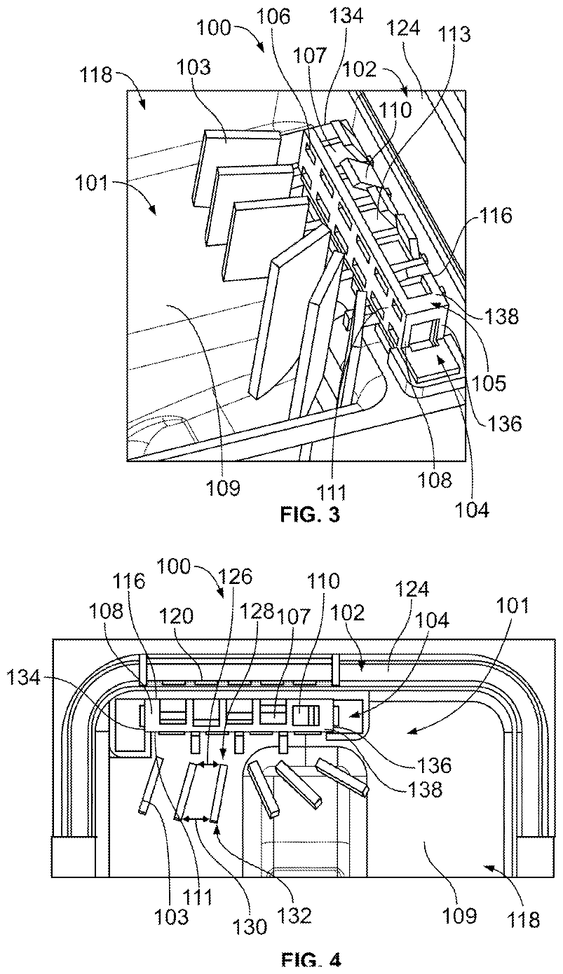

FIGS. 3-6 show a crankcase ventilation device 100 (e.g., an air-liquid separation assembly, breather, etc.), according to an embodiment. The crankcase ventilation device 100 includes a housing 102 defining an internal volume 101; a flow directing member, shown as media holder 104, coupled to the housing 102 within the internal volume 101; and a filter media 107. As shown in FIG. 3, the media holder 104 is coupled to a lower wall 109 of a base portion 118 (e.g., lower portion, etc.) of the housing 102. In at least one embodiment, the media holder 104 may be detachably coupled to the housing 102 via clips, latches, or another suitable fastener. In other embodiments, the media holder 104 may be permanently affixed to the housing 102. For example, the media holder 104 may be integrally formed with the base portion 118 of the housing 102 from a single piece of material (e.g., the media holder 104 may not be removable from the base portion 118 without damaging the media holder 104 and/or the base portion 118). In other embodiments, the media holder 104 may be permanently attached to the housing 102 via plastic welding operations such as sonic or vibration welding.

The crankcase ventilation device 100 is configured to separate liquid and air from a fluid, such as an air-liquid mixture, and may form, for example, part of a crankcase ventilation system that separates liquid oil from blow-by leaving an engine crankcase. Accordingly, the liquid and liquid particles referred to herein may be, for example, oil or oil particles. In particular, the crankcase ventilation device 100 may be used as part of an internal combustion engine system, such as a diesel engine, to improve oil and particle removal efficiency from blow-by, thereby reducing particulate emissions from the engine system.

In some embodiments, an inlet to the housing 102 may be fluidly coupled to an engine crankcase and configured to receive blow-by from the engine crankcase. The inlet may be fluidly coupled to the internal volume 101 by the media holder 104. In the embodiment of FIGS. 3-4, the housing 102 (e.g., base portion 118) includes a plurality of nozzles 120 disposed along an end wall of the base portion 118 that fluidly couple the inlet to the internal volume 101. The nozzles 120 are arranged in a row that is substantially aligned with a rear wall of the media holder 104. The nozzles 120 direct flow toward the media holder 104 to separate liquid oil from the blow-by entering the housing 102. The nozzles 120 may include openings in the end wall having a frusto-conical tapered transition to increase the velocity of the flow at it enters the housing 102. In other embodiments, the housing 102 may include only a single nozzle.

The media holder 104 supports the filter media 107 within the housing 102 and is structured to direct engine crankcase blow-by through the filter media 107 and into the internal volume 101. The filter media 107 may include a fibrous media having a plurality of layers of fibers forming a porous collection surface configured to capture and separate liquid particles from the incoming blow-by. The oil removed from the blow-by, via the crankcase ventilation device 100 (e.g., media holder 104, filter media 107, etc.), may collect and drain along the bottom of the base portion 118 (e.g., via a lower wall, trough, and/or depressed area of the base portion 118) back into the engine crankcase.

As shown in FIGS. 3-4, the base portion 118 of the housing 102 includes a lower wall (e.g., base wall, etc.) and a plurality of end walls 124 extending upwardly from an outer perimeter of the lower wall 109 in substantially perpendicular orientation relative to the lower wall 109. The housing 102 may further include an upper wall (e.g., cover, etc.) that couples to the lower wall 109 to substantially enclose the internal volume 101. The housing 102 may be made from a variety of materials. For example, the housing 102 may be injection molded from a glass-filled nylon material or formed from another suitable heat and chemical-resistant material. The lower wall 109 may define a drain for separated oil and one or more troughs (e.g., depressions, recessed areas, channels, etc.) that direct oil from various parts of the crankcase ventilation device 100 to the drain via gravity. Together, the lower wall 109 and the end walls 124 define at least a portion of the internal volume 101 of the housing 102. As shown in FIGS. 3-4, the media holder 104 is disposed proximate a rearmost one of the end walls 124 (e.g., a rear wall that at least partially defines the nozzles 120) and is oriented substantially parallel to the end wall 124.

The housing 102 is structured to improve oil separation and flow distribution downstream of the media holder 104. As shown in FIGS. 3-4, the housing 102 includes a plurality of housing baffles 103 (e.g., extensions, louvers, etc.) coupled to the lower wall 109 and extending upwardly (e.g., vertically away) from the lower wall 109 into the internal volume 101, in substantially perpendicular orientation relative to the lower wall 109. The housing baffles 103 are disposed in a substantially linear row downstream from a forward sidewall 111 of the media holder 104 that extends in a substantially parallel orientation relative to the forward sidewall 111 (e.g., across substantially an entire length of the forward sidewall 111). As shown in FIG. 4, a first spacing between adjacent ones of the housing baffles 103 is approximately equal to a second spacing between the housing baffles 103 and the forward sidewall 111 of the media holder 104. In other embodiments, the first spacing and the second spacing may be different.

The housing baffles 103 may form a flow diffuser of the housing 102 and/or sub-separator downstream of the media holder 104 to help separate any remaining oil from the flow leaving the media holder 104. As shown in FIG. 4, the housing baffles 103 are angled with respect to the forward sidewall 111 to distribute flow throughout the internal volume 101. The housing baffles 103 are fanned away from one another such that a first separation distance 126 between adjacent ones of the housing baffles 103 at a first end 128 of the housing baffles 103, proximate to the forward sidewall 111, is less than a second separation distance 130 between adjacent ones of the housing baffles 103 at a second end 132 of the housing baffles 103 opposite the first end 128. In other embodiments, the arrangement of housing baffles 103 may be different. For example, the housing baffles 103 may be arranged substantially parallel to one another within the housing 102 and/or substantially parallel to a flow direction through the housing 102. The placement of housing baffles 103 depends, among other factors, on the location of the media holder 104 within the housing 102 and the direction in which the flow is to be guided/distributed for better flow distribution throughout the housing 102.

The housing baffles 103 may be integrally formed with the housing 102 (e.g., the base portion 118) from a single piece of material (e.g., from plastic via an injection molding operation, etc.). In other embodiments, the housing baffles 103 may be formed separately from the housing 102. The size (e.g., thickness, length, height, etc.), positioning, and arrangement of the housing baffles 103 may be different in other embodiments. Among other benefits, the housing baffles 103 provide additional surfaces for the oil to collect and separate from the incoming fluid. The housing baffles 103 also help distribute the flow more uniformly throughout the housing 102, minimizing dead volume, and reducing the maximum continuous flow velocity that can be achieved through the housing 102 (e.g., from the inlet to the outlet), which improves oil separation and prevents liquid carryover from the surfaces of the housing into the separated air flowing through the housing.

The media holder 104 is structured to support the filter media 107 within the housing and to improve flow distribution throughout the housing 102 downstream of the filter media 107. As shown in FIG. 3, the media holder 104 includes a body 105 in the shape of a right prism (e.g., cube, rectangular projection, etc.). The body 105 includes a plurality of sidewalls 108 defining an interior cavity 113 (e.g., recessed area, hollow interior, interior volume, etc.) that is sized to receive the filter media 107 therein. The sidewalls 108 include a rear sidewall 116 (e.g., a first sidewall, etc.), a forward sidewall 111 (e.g., a second sidewall, etc.) spaced apart from the rear sidewall 116 and oriented substantially parallel to the rear sidewall 116, a right sidewall 134 (e.g., a third sidewall, etc.) extending between the forward sidewall 111 and the rear sidewall 116 at a first end of the media holder 104 (e.g., a first lateral end of the media holder 104), a left sidewall 136 (e.g., a fourth sidewall, etc.) extending between the forward sidewall 111 and the rear sidewall 116 at a second end of the media holder (e.g., a second lateral end of the media holder 104 opposite the first lateral end), and an upper sidewall 138 coupled to an upper end of each of the forward sidewall 111, rear sidewall 116, right sidewall 134, and left sidewall 136 and covering the interior cavity formed between the forward sidewall 111, rear sidewall 116, right sidewall 134, and left sidewall 136. As shown in FIG. 4, a length of the right sidewall 134 and the left sidewall 136 is less than a length of the forward sidewall 111 and the rear sidewall 116 such that the media holder 104 defines an elongated rectangular cube shape. In other embodiments, the dimensions of the media holder may be different.

The media holder 104 includes openings (shown as openings 514 in FIG. 13) on the rear sidewall 116 of the body 105, through which the flow is directed to impact the filter media. The media holder 104 also includes a plurality of windows 106 (e.g., openings, apertures, etc.) disposed on the remaining sidewalls 108 (e.g., faces, etc.) of the body 105 (e.g., the forward sidewall 111, the upper sidewall 138, etc.). The windows 106 fluidly couple the interior cavity of the media holder 104 to the internal volume 101 of the housing 102. In the embodiment of FIG. 3, multiple windows 106 are disposed on each of the sidewalls 108, which allows flow to travel through the media holder 104 and into the internal volume 101 in all directions (i.e., through each one of the sidewalls 108 including the forward sidewall 111, right sidewall 134, left sidewall 136, and upper sidewall 138). The windows 106 are sized to control the flow rate through each of the sidewalls 108, for example, by controlling relative open area and/or open area ratio on each of the sidewalls 108. As used herein, the term “open area ratio” refers to a fraction of the total area of a given sidewall 108 that is open to flow (e.g., a fraction of the total area that is occupied by the windows 106).

Among other benefits, controlling the relative open area (e.g., combined area of the windows 106) between different sidewalls 108 of the media holder 104 allows for changes in the relative flow rates through each sidewall 108. For example, including more windows 106 of similar size on the upper sidewall 138 as compared to the forward sidewall 111 will result in a larger flow rate through the upper sidewall 138 than the forward sidewall 111. In this way, the fractional flow rates through each of the sidewalls 108 can be controlled to improve flow distribution through the housing 102.

As shown in FIGS. 3-6, the media holder 104 further includes a plurality of flow directing baffles 110 (e.g., tabs, louvers, etc.), each extending from an edge of a respective one of the windows 106, away from a respective one of the sidewalls 108 and into the internal volume 101. The plurality of flow directing baffles 110 together form a flow diffuser for the media holder 104. In the embodiment of FIGS. 3-6, the flow directing baffles 110 are disposed on only the upper sidewall 138 of the body 105. In other embodiments, the flow directing baffles 110 may also be disposed on other sidewalls 108 of the body 105 (e.g., the forward sidewall 111, right sidewall 134, left sidewall 136, and/or rear sidewall 116).

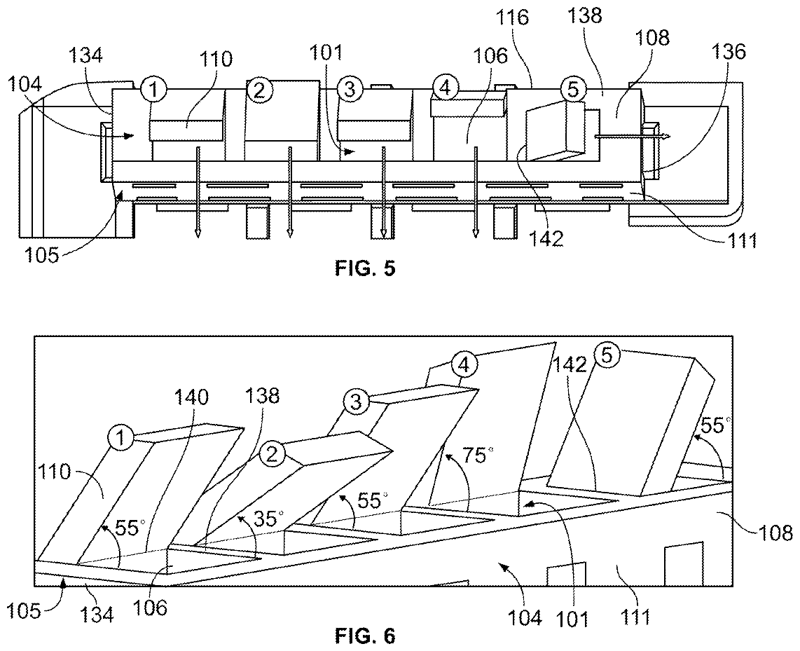

As shown in FIGS. 5-6, the flow directing baffles 110 are angled in one of two directions within the housing 102. In other words, at least a first one of the flow directing baffles 110 is angled in a first direction and at least a second one of the flow directing baffles is angled in a second direction that is different from the first direction. In the embodiment of FIGS. 5-6, a first flow directing baffle is disposed on a rear edge 140 (e.g., a first edge) of a first one of the windows 106 and is angled to direct flow toward the forward sidewall 111 (e.g., to a longitudinal end of the housing 102 opposite the media holder 104). A second flow directing baffle is disposed on a lateral edge 142 (e.g., side edge that is perpendicular to the rear edge, a second edge, etc.) on a second one of the windows 106 and is angled to direct flow toward the left sidewall 136 (e.g., toward a lateral end of the housing 102) in a substantially perpendicular direction relative to the flow leaving through the first flow directing baffle. In another embodiment, the flow directing baffles 110 may additionally or alternatively be oriented to direct flow toward the right sidewall 134 or the rear sidewall 116, or toward both walls simultaneously.

In the embodiment of FIGS. 5-6, four of the flow directing baffles 110 closest to the right sidewall are disposed along and directly coupled to a rear edge of a respective one of the windows 106 to direct flow toward the forward sidewall 111. As shown in FIG. 6, the four flow directing baffles 110 are oriented at different angles to improve flow distribution across the crankcase ventilation device 100. For example, a first one of the flow directing baffles 110, nearest the right sidewall 134, is oriented at a first angle of approximately 55 degrees relative to the upper sidewall 138. A second flow directing baffle adjacent to the first flow directing baffle is oriented at an angle of approximately 35 degrees relative to the upper sidewall 138. A third flow directing baffle, adjacent to the second flow directing baffle, is oriented at an angle of approximately 55 degrees with respect to the upper sidewall 138. A fourth flow directing baffle, adjacent to the third flow directing baffle, is oriented at an angle of approximately 75 degrees relative to the upper sidewall 138. A fifth flow directing baffle, closest to the left sidewall 136, is disposed along a side edge of its respective window 106 to direct flow toward the left sidewall. In other embodiments, the angle formed between the flow directing baffles may be different.

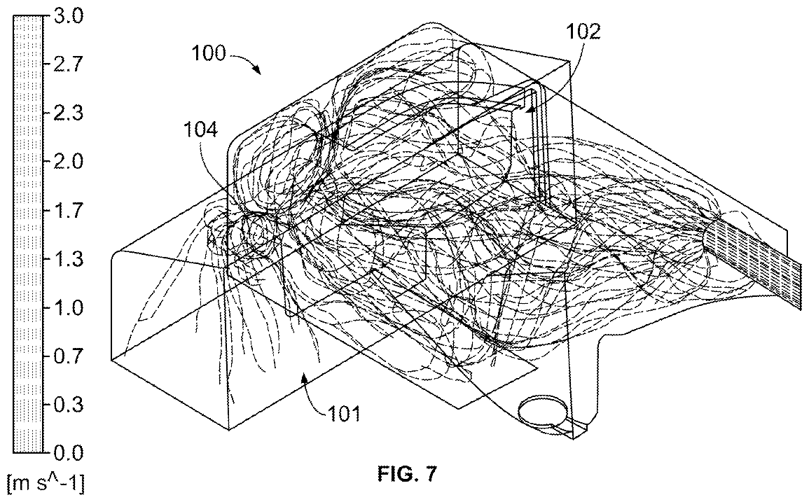

As shown in FIG. 7, the structure of the media holder 104 and angled baffles (e.g., the housing baffles and flow directing baffles) improves flow distribution throughout the crankcase ventilation device 100 (e.g., throughout the internal volume 101 of the housing 102), minimizing dead volumes and/or areas of flow recirculation within the housing, which reduces flow velocity and improves oil separation efficiency.

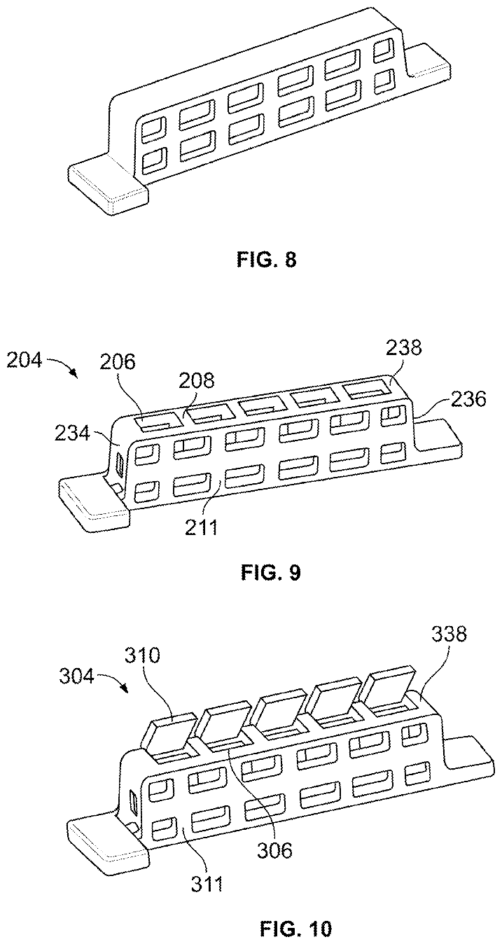

The design and arrangement of components described with reference to the embodiments FIGS. 3-6 should not be considered limiting. Many alternatives and combinations are possible without departing from the inventive concepts disclosed herein. For example, FIGS. 8-11 show examples of different structures that can be used for the flow directing member (e.g., media holder). FIG. 9 shows the addition of windows 206 to each sidewall 208 (in addition to the forward sidewall as shown in FIG. 8). In particular, the media holder 204 of FIG. 9 includes two separate rows of windows 206 on a forward sidewall 211, a single row of windows 206 along an upper sidewall 238, and individual windows on the right sidewall 234 and opposing left sidewall 236. The arrangement and number of windows 206 along each sidewall 208 may be different in other embodiments, and may be determined, at least in part, based on the dimensions of each sidewall 208.

FIG. 10 shows the addition of flow directing baffles 310 to the windows 306 along the upper sidewall 338 of the flow directing member (e.g., media holder 304). In the embodiment of FIG. 10, the flow directing baffles 310 are all oriented in the same direction. In particular, the flow directing baffles 310 are each directly coupled to a rear edge of a respective one of the windows 306 and directed toward a forward sidewall 311 of the media holder 304. The flow directing baffles 310 are all arranged at substantially the same angle relative to the upper sidewall 338 (e.g., approximately 55 degrees relative to the upper sidewall 338). Additionally, a spacing between adjacent rows of windows 306 along the forward sidewall 311 of the media holder 304 is greater than a spacing between adjacent rows of windows 206 along the forward sidewall 211 of the media holder 204 in FIG. 9.

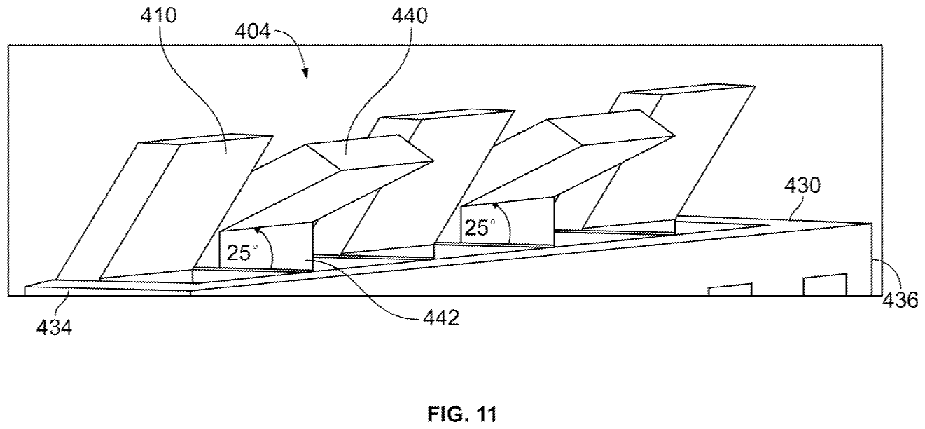

As shown in FIG. 11, the flow directing baffles 410 of the flow directing member (e.g., media holder 404), along the upper sidewall 430 of the flow directing member, are alternately arranged at different angles in a pattern between the right sidewall 434 and the left sidewall 436, such that an angle of every other one of the flow directing baffles 410 with respect to the upper sidewall 430 is reduced relative to adjacent ones of the flow directing baffles 410. Additionally, an angled portion 440 of an intervening set of the flow directing baffle 410 (e.g., every other one of the flow directing baffles 410) are spaced vertically apart from the upper sidewall 430 by an extension piece 442 that extends away from a rear edge of the upper sidewall 430 in a substantially perpendicular orientation relative to the upper sidewall 430. A length of the extension piece 442 relative to the angled portion 440 may be different in other embodiments. Among other benefits, the variation in angles, geometry, and/or spacing of the flow directing baffles may increase liquid separation performance by more fully distributing flow throughout the internal volume of the housing.

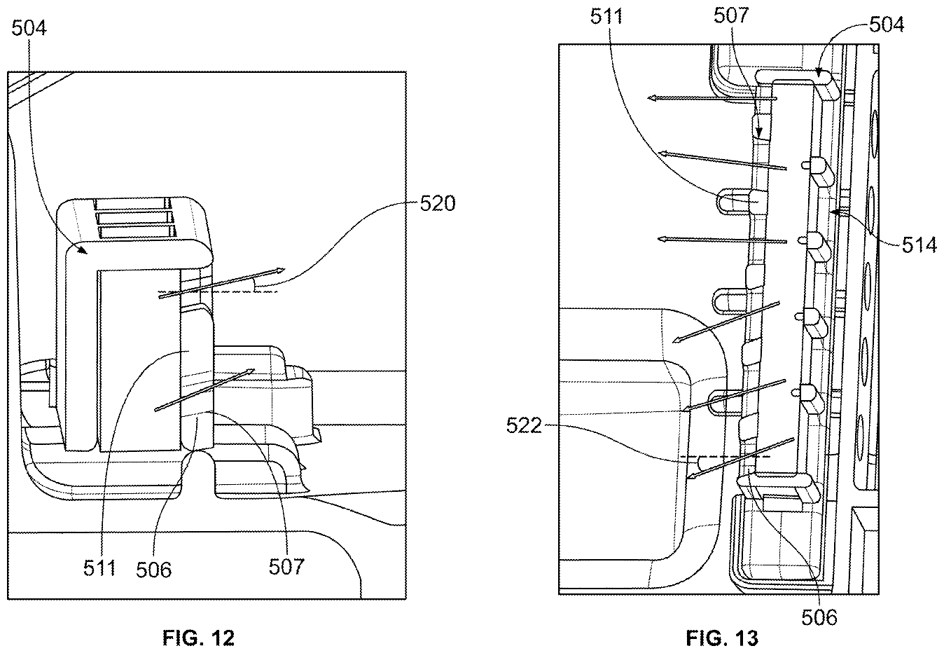

FIGS. 12-13 show an embodiment of a flow directing member, shown as media holder 504, in which the windows 506 along a forward sidewall 511 are angled to direct the flow at both a first angle 520 with respect to the forward sidewall 511 of the housing (e.g., toward an upper or lower wall of the housing) and a second angle 522 with respect to the right sidewall and/or left sidewall 136 of the media holder 504 (e.g., toward a left or right wall of the housing). In particular, at least perimeter surface 507 of the window 506 may be oriented at an oblique angle (e.g., a non-right angle or any multiple of a right angle) relative to the forward sidewall 511. As shown in FIGS. 12 and 13, the angles formed by each of the windows 506 varies between the windows 506 along the forward sidewall 511 (e.g., between adjacent rows of windows 506 and individual widows 506 within each row) to improve flow distribution within the housing. For example, as shown in FIG. 12, a lower window may have a steeper first angle 520 than an upper window to account for the lower vertical position of the lower window, and to promote flow distribution throughout the housing. As shown in FIG. 13, the second angle 522 varies between adjacent windows within each row to fan the flow out into the housing. It will be appreciated that the perimeter walls of each window may be angled in any direction to facilitate flow distribution and that the windows along other sidewalls may also be angled to improve the overall flow distribution and liquid separation performance.

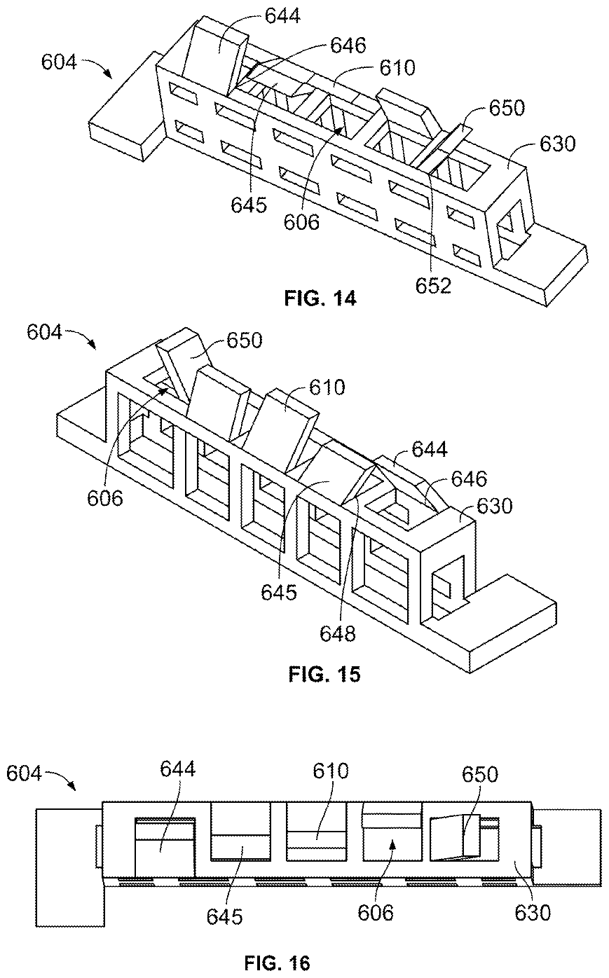

FIGS. 14-16 show another embodiment of a flow directing member, shown as media holder 604, in which at least one flow directing baffle is a reverse flow baffle that is oriented to direct flow back toward an inlet of the housing (e.g., toward an end of the housing at which the inlet nozzles are located, a rear/back wall of the housing, etc.). As shown, the media holder includes a plurality of flow directing baffles 610 engaged with and protruding upwardly from an upper sidewall 630 of the media holder, adjacent to each window 606 along the upper sidewall 630, similar to the embodiment described with reference to FIGS. 10 and 11. However, unlike the media holder of FIGS. 10-11, the flow directing baffles 610 of the media holder 604 of FIGS. 14-16 are configured to direct flow toward a forward end, a rear end, and at least one side of the housing (e.g., a sidewall of the housing extending between the forward end and the rear end) at the same time. In particular, a first flow directing baffle 644 is disposed along a forward edge 646 of a first window and is angled toward an inlet end of the housing (e.g., toward the nozzles, toward a rear end of the housing, etc.). A second flow directing baffle 645 is disposed on a rear edge 648 of a second window (e.g., a second window that is adjacent to the first window), and is angled toward an outlet end of the housing (e.g., toward an outlet, toward a forward end of the housing, etc.). A third flow directing baffle 650 is disposed on a side edge 652 of a third window (e.g., a third window that is disposed at an opposing end of the upper sidewall 630 as the first window), and is angled toward a side wall of the housing that extends between the inlet end and the outlet end of the housing. The arrangement of flow directing baffles may be different in various embodiments.

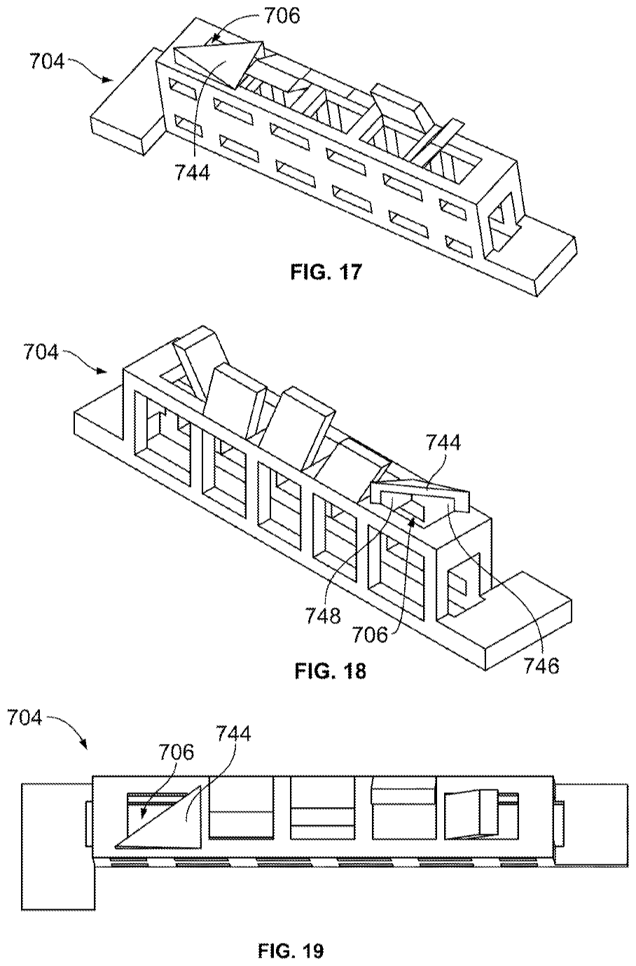

FIGS. 17-19 show another embodiment of a flow directing member, shown as media holder 704, in which at least one of the flow directing baffles is non-perpendicular or parallel to the other flow directing members. In particular, a first flow directing baffle 744 is configured to direct flow at an oblique angle relative to the edges of a respective one of the windows 706. In the embodiment of FIGS. 17-19, the first flow directing baffle 744 is disposed along a forward edge 746 and an adjacent side edge 748 of a respective one of the windows 706 and is arranged to direct flow at an approximately 45 degree angle relative to the forward edge 746 and the side edge 748 (e.g., to direct flow at least partially toward an inlet end of the housing as well as a side of the housing between the inlet and outlet ends of the housing). As shown in FIG. 19, the first flow directing baffle 744 is an at least partially enclosed structure that covers approximately half (e.g., a triangular-shaped portion) of a respective one of the windows 706. An upper wall of the first flow directing baffle 744 is angled upwardly from a forward corner of the window 706. In other embodiments, the shape, size, and orientation of the flow directing baffles may be different.

### III. Construction of Example Embodiments

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments.
Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A crankcase ventilation device, comprising:
a housing defining an inlet, an outlet, and an internal volume, the inlet configured to receive blow-by from an engine; and
a flow directing member coupled to the housing and extending into the internal volume, the flow directing member comprising a plurality of sidewalls, a first sidewall of the plurality of sidewalls defining a first window and a second window, the flow directing member structured to direct flow leaving through the first window at a first angle relative to the first sidewall that is different from a second angle of the flow leaving through the second window.

2. The crankcase ventilation device of claim 1, wherein the flow directing member further comprises a flow directing baffle disposed along an edge the first window and extending away from the first sidewall of the plurality of sidewalls.

3. The crankcase ventilation device of claim 2, wherein the flow directing baffle is oriented at an oblique angle with respect to the first sidewall.

4. The crankcase ventilation device of claim 2, wherein the flow directing baffle is one of a plurality of flow directing baffles, wherein a first one of the plurality of flow directing baffles is disposed on a first edge of the first window and a second one of the plurality of flow directing baffles is disposed on a second edge of the second window that is adjacent to the first window, the first edge being substantially perpendicular to the second edge.

5. The crankcase ventilation device of claim 2, wherein the flow directing baffle is one of a plurality of flow directing baffles coupled to the first sidewall, and wherein a first angle between a first one of the plurality of flow directing baffles and the first sidewall is different from a second angle between a second one of the plurality of flow directing baffles and the first sidewall.

6. The crankcase ventilation device of claim 2, wherein the flow directing baffle is one of a plurality of flow directing baffles coupled to the first sidewall, and wherein the plurality of flow directing baffles are alternately arranged at different angles in a pattern between opposing sidewalls of the flow directing member.

7. The crankcase ventilation device of claim 2, wherein the flow directing baffle is angled toward the inlet.

8. The crankcase ventilation device of claim 1, further comprising a plurality of housing baffles extending upwardly from a lower wall of the housing downstream from the flow directing member.

9. The crankcase ventilation device of claim 8, wherein the plurality of housing baffles are arranged in a substantially linear row downstream from a forward sidewall of the flow directing member.

10. The crankcase ventilation device of claim 1, further comprising a filter media coupled to the flow directing member.

11. The crankcase ventilation device of claim 1, wherein a perimeter surface of the first window is oriented at an oblique angle relative to the first sidewall.

12. The crankcase ventilation device of claim 1, wherein together the plurality of sidewalls of the flow directing member form a shape of a right prism.

13. The crankcase ventilation device of claim 1, wherein the housing further comprises a plurality of nozzles arranged in a row that is substantially aligned with the flow directing member, the plurality of nozzles positioned to direct flow toward the flow directing member.

14. A flow directing member, comprising:
a body comprising a plurality of sidewalls, the plurality of sidewalls together defining an interior cavity sized to receive a filter media therein, the plurality of sidewalls comprising:
a first sidewall defining an opening; and
a second sidewall coupled to the first sidewall, the second sidewall defining a first window and a second window that are fluidly coupled to the opening by the interior cavity, the body structured to direct flow leaving through the first window at a first angle that is different from a second angle of the flow leaving through the second window.

15. The flow directing member of claim 14, further comprising a flow directing baffle disposed on an edge of the first window and extending away from the first sidewall.

16. The flow directing member of claim 15, wherein the flow directing baffle is one of a plurality of flow directing baffles including a first flow directing baffle disposed on a first edge of the first window and a second flow directing baffle disposed on a second edge of the second window, the first edge being substantially perpendicular to the second edge.

17. The flow directing member of claim 14, wherein the first window is one of a first plurality of windows arranged in a first row along the first sidewall and the second window is one of a second plurality of windows arranged in a second row along the first sidewall.

18. A flow directing member, comprising:
a body comprising a plurality of sidewalls, the plurality of sidewalls together defining an interior cavity sized to receive a filter media therein, the plurality of sidewalls comprising a first sidewall defining a first window and a second window; and
a flow directing baffle disposed along an edge of the first window and extending away from the first sidewall at an oblique angle relative to the first sidewall, the flow directing baffle directing flow leaving through the first window at a first angle relative to the first sidewall that is different from a second angle of the flow leaving through the second window.

19. The flow directing member of claim 18, wherein the plurality of sidewalls includes a second sidewall defining a plurality of windows extending along the second sidewall.

20. The flow directing member of claim 19, wherein the flow directing baffle is one of a plurality of flow directing baffles including a first flow directing baffle disposed on a first edge of a first one of the plurality of windows and a second flow directing baffle disposed on a second edge of a second one of the plurality of windows, the first edge being substantially perpendicular to the second edge.

21. The flow directing member of claim 18, wherein the flow directing baffle is one of a plurality of flow directing baffles coupled to the first sidewall, and wherein a first angle between a first one of the plurality of flow directing baffles and the first sidewall is different from a second angle between a second one of the plurality of flow directing baffles and the first sidewall.
